(19) United States
(12) Patent Application Publication
(10) Pub. No.: US 2006/0069745 A1
(43) Pub. Date: Mar. 30, 2006

(54) Method, system and program product for identifying web page dependencies

(75) Inventors: Ryan A. Boyles, Raleigh, NC (US); Nathanael F. Ehrich, Raleigh, NC (US); Jason C. Plurad, Raleigh, NC (US); Laquicia S. Russ, Durham, NC (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 10/935,830

(22) Filed: Sep. 8, 2004

(51) Int. Cl. G06F 15/16

(52) U.S. Cl. 709/218

(57) ABSTRACT

Under the present invention provides a method, system and program product for identifying web page dependencies. Specifically, under the present invention, any dependencies needed to properly view a web page are identified prior to rendering the web page on the client. Once any dependencies are identified, the client from which the web page was requested is analyzed to determine whether it has the needed dependencies. Thereafter, graphical dependency indicators that indicate the dependencies and whether they exist on the client can be displayed

### BACKGROUND OF THE INVENTION

1. Field of the Invention

In general, the present invention provides a method, system and program product for identifying web page dependencies. Specifically, the present invention identifies web page dependencies, determines whether a client requesting a web page has the necessary dependencies, and provides a way to obtain any dependencies that are lacking.

2. Related Art

Over the years, the Internet has become an everyday part of our lives. Today many people use the Internet to perform both work-related and personal tasks. For example, not only can an individual use the Internet to communicate and collaborate with other workers, but the individual can also use the Internet to perform personal tasks such as shopping, bill paying, etc. Currently, users visit web pages via a hyperlink in a search engine result set, by directly typing a Uniform Resource Locator (URL) into a browser, selecting a bookmark or other hyperlink, etc. As the requested web page loads, dependencies are discovered. For example, the web page may embed a Macromedia Flash object or Java Applet within the page. As a result, third-party plugins are required to properly view this web page. In other words a dependency is formed. Examples of such dependencies include: (1) plugin software or ActiveX controls; (2) Operating System vendor and version; (3) Internet Browser vendor and version; (4) Internet Browser settings (e.g. JavaScript enabled, plugins enabled); etc.

The correct dependencies may exist on the requesting client, and the page may load seamlessly. However, the necessary dependencies may not be installed on the client computer or the correct version may not be installed. The result is an incomplete web page that often, but not always, notifies the user that the client lacks a dependent piece of software or setting. It is then up to the user to follow the suggested mechanism for retrieving the necessary component.

Unfortunately, existing retrieval mechanisms typically vary per vendor. Moreover, the presence of plugins and the like from multiple vendors may cause other problems. For example, a web page may include a Macromedia Flash object and a QuickTime streaming video clip. Thus, in order to properly view the page, the user must potentially visit two websites and perform two plugin installations or upgrades. Still yet, some plugins require that the computer or browser be restarted before they become available. Thus, if plugins are installed separately, the computer or browser may need to be restarted multiple times. Such problems can occur for any type of dependency.

In view of the foregoing, there exists a need for a method, system and program product for identifying web page dependencies. Specifically, a need exists for a system that can identify web page dependencies and determine whether a client has the needed dependencies. A further need exists for a system that graphically indicates dependencies for a requested web page, and whether the client has the dependencies.

### SUMMARY OF THE INVENTION

In general, the present invention provides a method, system and program product for identifying web page dependencies. Specifically, under the present invention, any dependencies needed to properly view a web page are identified prior to rendering the web page on the client. Once any dependencies are identified, the client from which the web page was requested is analyzed to determine whether it has the needed dependencies. Thereafter, graphical dependency indicators that indicate the dependencies and whether they exist on the client can be displayed.

A first aspect of the present invention provides a method for identifying web page dependencies, comprising: identifying a set of dependencies corresponding to a web page prior to rendering the web page; determining whether a client from which the web page was requested has the set of dependencies; and graphically indicating the set of dependencies on the client and whether the client has the set of dependencies.

A second aspect of the present invention provides a system for identifying web page dependencies, comprising: a system for identifying a set of dependencies corresponding to a web page prior to rendering the web page; a system for determining whether a client from which the web page was requested has the set of dependencies; and a system for graphically indicating the set of dependencies on the client, and whether the client has the set of dependencies.

A third aspect of the present invention provides a program product stored on a recordable medium for identifying web page dependencies, which when executed, comprises: program code for identifying a set of dependencies corresponding to a web page prior to rendering the web page; program code for determining whether a client from which the web page was requested has the set of dependencies; and program code for graphically indicating the set of dependencies on the client, and whether the client has the set of dependencies.

A fourth aspect of the present invention provides a method for deploying an application for identifying web page dependencies, comprising: providing a computer infrastructure being operable to: identify a set of dependencies corresponding to a web page prior to rendering the web page; determine whether a client from which the web page was requested has the set of dependencies; and graphically indicate the set of dependencies on the client, and whether the client has the set of dependencies.

A fifth aspect of the present invention provides computer software embodied in a propagated signal for identifying web page dependencies, the computer software comprising instructions to cause a computer system to perform the following functions: identify a set of dependencies corresponding to a web page prior to rendering the web page; determine whether a client from which the web page was requested has the set of dependencies; and graphically indicate the set of dependencies on the client, and whether the client has the set of dependencies.

Therefore, the present invention provides a method, system and program product for identifying web page dependencies.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative system for identifying web page dependencies according to the present invention.

FIG. 2 depicts illustrative icons indicating dependencies and whether they exist on the client according to the present invention.

FIG. 3 depicts the illustrative icons of FIG. 2 as used in conjunction with search results according to one embodiment of the present invention.

FIG. 4 depicts a pop-up window to graphically indicate dependencies and their existence on the client according to another embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

As indicated above, the present invention provides a method, system and program product for identifying web page dependencies. Specifically, under the present invention, any dependencies needed to properly view a web page are identified prior to rendering the web page on the client. Once any dependencies are identified, the client from which the web page was requested is analyzed to determine whether it has the needed dependencies. Thereafter, graphical dependency indicators that indicate the dependencies and whether they exist on the client can be displayed. As used herein, the term “dependency” is intended to mean any type of hardware or software component that is needed in order for a web page to properly load, execute and/or be viewed. Examples include plugin software or ActiveX controls, Operating System vendor and/or version, Internet Browser vendor and/or version, Internet Browser settings (e.g. JavaScript enabled, plugins enabled) etc. In addition, the term “set” is intended to mean one or more.

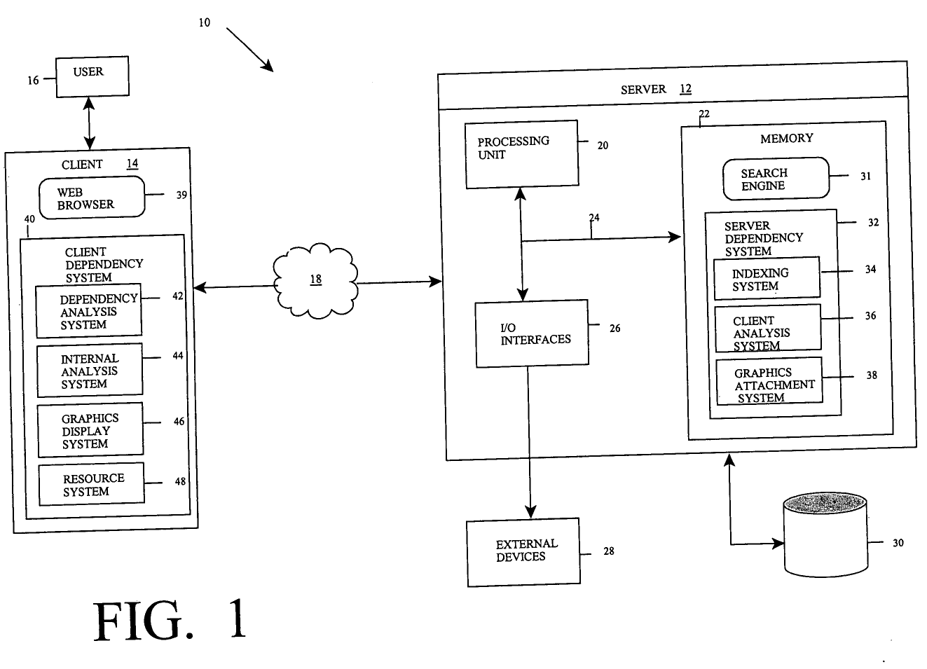

Referring now to FIG. 1, an illustrative system 10 for identifying web page dependencies according to the present invention is shown. Specifically, under the present invention, system 10 is capable of: (1) identifying any web page dependencies; (2) determining whether a client requesting a web page has the necessary dependencies; (3) graphically indicating the dependencies on the client, and whether the client has the same; and (4) providing a mechanism for obtaining any missing dependencies. To this extent, system 10 depicts server 12 in communication with client 14. In this illustrative embodiment, it can be assumed that user 16 operates client 14 to request one or more web pages from server 12. To this extent, server 12 can be a web server, a portal server, or the like. As will be further described below, the underlying functionality of the present invention can be implemented via server side technology, client side technology, or by a combination thereof.

In any event, server 12 and client 14 are intended to represent any type of computerized devices capable of carrying out the teachings of the present invention. For example, client 14 could be a desktop computer, a laptop computer, a workstation, a handheld device, etc. Moreover, as shown, server 12 and client 14 communicate over a network 18, which is intended to represent any type of network such as the Internet, a local area network (LAN), a wide area network (WAN), a virtual private network (VPN), etc. Regardless, communication between server 12 and client 14 could occur via a direct hardwired connection (e.g., serial port), or via an addressable connection that may utilize any combination of wireline and/or wireless transmission methods. Conventional network connectivity, such as Token Ring, Ethernet, WiFi or other conventional communications standards could be used. Still yet, connectivity could be provided by conventional IP-based protocol. In this instance, an Internet service provider could be used to establish interconnectivity.

As further shown, server 12 generally includes processing unit 20, memory 22, bus 24, input/output (I/O) interfaces 26, external devices/resources 28 and storage unit 30. Processing unit 20 may comprise a single processing unit, or be distributed across one or more processing units in one or more locations, e.g., on a client and server. Memory 22 may comprise any known type of data storage and/or transmission media, including magnetic media, optical media, random access memory (RAM), read-only memory (ROM), a data cache, a data object, etc. Moreover, similar to CPU 20, memory 22 may reside at a single physical location, comprising one or more types of data storage, or be distributed across a plurality of physical systems in various forms.

I/O interfaces 26 may comprise any system for exchanging information to/from an external source. External devices/resources 28 may comprise any known type of external device, including speakers, a CRT, LED screen, hand-held device, keyboard, mouse, voice recognition system, speech output system, printer, monitor/display, facsimile, pager, etc. Bus 24 provides a communication link between each of the components in server 12 and likewise may comprise any known type of transmission link, including electrical, optical, wireless, etc.

Storage unit 30 can be any system (e.g., a database, etc.) capable of providing storage for information under the present invention. Such information could include, among other things, an index of web page dependencies. As such, storage unit 30 could include one or more storage devices, such as a magnetic disk drive or an optical disk drive. In another embodiment, storage unit 30 includes data distributed across, for example, a local area network (LAN), wide area network (WAN) or a storage area network (SAN) (not shown). Although not shown, additional components, such as cache memory, communication systems, system software, etc., may be incorporated into server 12. Moreover, it should be clearly understood that client 14 will typically include computerized components similar to server 12. Such components have not been shown in FIG. 1 for brevity purposes.

As indicated above, the functionality provided by the present invention can be provided in multiple ways. Specifically, the teachings of the present invention can be implemented via server side technology, client side technology, or by a combination thereof. For illustrative purposes, a first embodiment of the present invention will be described in conjunction with server side technology.

To this extent, as shown, memory 22 of server 12 includes search engine 31 and server dependency system 32, which itself includes indexing system 34, client analysis system 36 and graphics attachment system 38. Although shown as separate systems, search engine 31 and server dependency system 32 could be incorporated as a single system. For example, an existing search engine could incorporate server dependency system 32 to provide the functionality of the present invention. Regardless, indexing system 34 analyzes the web pages available through search engine 31 and indexes any dependencies thereof. Specifically, by using an indexing system similar to that used by web crawlers (e.g., Google) to index and surface available web pages, the web pages and their respective dependencies could be discovered. In a typical embodiment, indexing system 34 would crawl through the web, parse web pages and analyze the following:

(a) META tags—dependencies exposed by content provider. Specifically, content providers may include META tags within indexable web page markup that exposes dependencies. As known, META tags are informational tags inserted into the head portion of an HTML document. The information stored here is not seen by users visiting the particular web site. One of the main reasons that web page designers use META tags is to perhaps have better control over how their web site is described and searched when shown in a search engine's result set. For example the below code segment shows META tags that define what description to show and what additional keywords to index in additional to the text contained in the body of the document.
<HEAD>
<TITLE>
Sample Web page example
<TITLE>
<META name=“description” content=“This is merely a more detail description of this web page”>
<META name=“keyword” content=“sample, example, webpage”>
</HEAD>
   This concept can be expanded upon, by allowing content providers to expose rich content dependencies. For example, a tag such as the following could be used:
   <META name=“dependencies” content=“javascript, quicktime, flash, adobe”>
   In an embodiment such as this, the names used for the “content” portion of this tag could be standardized to allow for multiple engines to recognize and visually render the dependencies correctly. Alternatively, mime-types could be used.
<META name=“mime-types”
content=“text/javascript,video/mpeg,application/pdf”>

(b) HTML content—inclusion of rich content on a web page. Specifically, indexing system 34 could also discover links to rich content in HTML tags such as <APPLET>, <SCRIPT> and <OBJECT>.

While indexing a website, indexing system 34 could parse the content of each web page and follow discovered links to establish page relationships. Currently, Google uses this data to rank pages so that the pages referenced/linked most by other pages are ranked highest. Under the present invention, as indexing system 34 evaluates hyperlinks on a page, it can also go a step further and follow the link to evaluate dependencies on the subsequent page. Indexing system 34 can then aggregate this information and surface intelligent conclusions. For example, the search engine results might indicate that while Macromedia Flash is not needed on the immediate page (first level), a number of subsequent pages (second-level) require the Macromedia plugin to display correctly. Thus, the page has a “Level 2” dependency on Flash. User 16, understanding this ranking/priority system, can then make a decision on whether or not to take the time to install the necessary software. It might be that user 16 only envisions visiting the front page, thus eliminating any dependency. This could continue up to N levels. If user 16 is likely to encounter a dependency on Flash within three clicks into the website, the search engine could indicate a “Level 3” dependency on Flash.

In any event, assume that indexing system 34 has indexed the dependencies for available web pages. Such an index can be maintained, for example, in storage unit 30. Further assume that some time later, user 16 utilizes a web browser 39 on client 14 to request a certain web page or submit a search query. As is well known, the request or query will be received on server 12 by search engine 31. Under the present invention, prior to providing the results to user 16, indexing system 34 will access the index in storage unit 30 and identify any dependencies. If a single web page was requested, the dependencies for the single web page will be identified. Alternatively, if a search query was submitted, the dependencies for each of the search results (web pages) produced by the search engine 31 will be identified. Should a set of dependencies exist, client analysis system 36 can query or analyze client 14 to determine whether it has the needed set of dependencies. If client 14 is merely queried, internal analysis system 44 can perform the actual analysis of client 14 to determine whether it has the set of dependencies. Conversely, with sufficient access and security, client analysis system 36 can perform the analysis from server 12.

Assume in this example that user 16 submitted a search query via browser 39 and that a set of dependencies exist for one or more of the results. Graphics attachment system 38 will graphically indicate the dependencies for the results for user 16. In graphically indicating the dependencies, graphics attachment system 38 can include icons, plain text or any other graphical dependency indicator that corresponds to the set of dependencies in the search results rendered in browser 39. Such indicators can be depicted in a certain manner based on whether client 14 has the particular dependencies. Moreover, as will be further described below, the graphical dependency indicators could be displayed automatically for user 16, or they cold be displayed upon manual prompting by user 16 (e.g., upon the selection of an icon in a toolbar of browser 39).

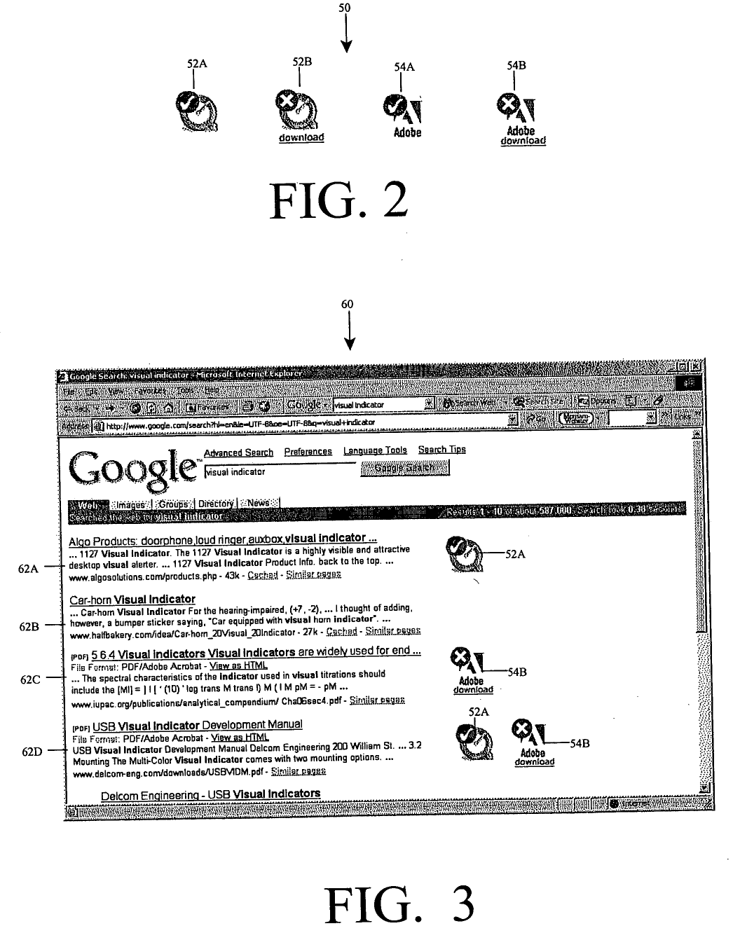

For example, referring now to FIG. 2, illustrative icons 50 corresponding to a set of dependencies are depicted. Icons 52A-B correspond to a particular plugin (e.g., QuickTime) needed for a web page, while icons 54A-B correspond to a particular software application (e.g., Adobe Acrobat) needed for a web page. Icons 52A-B and 54A-B are depicted in a first and second manner depending on whether the corresponding dependencies exist on client 14. Specifically, icons 52A and 54A indicate that client 14 has the corresponding plugin and software application. Conversely, icons 52B and 54B indicate that client 14 lacks the corresponding plugin and software application. By depicting icons in a first and second manner such as shown in FIG. 2, user 16 can not only be made aware of what the dependencies are for a web page, but also whether his/her client 14 has those dependencies. It should be understood that icons 52A-B and 54A-B are intended to be illustrative only and that any type of mechanism for graphically indicating a needed dependency, as well as whether the requesting client includes the needed dependency, can be implemented under the present invention. For example, the graphical dependency indicators could be plain text that indicates the dependencies and whether client 14 includes the same.

Regardless, the use of icons 52A-B and 54A-B is shown in greater detail in FIG. 3. Specifically, FIG. 3 depicts illustrative search results 60 that were returned by search engine 31 pursuant to a search query of “visual indicator” as input by user 16 via web browser 39. As can be seen, search results 60 include four web pages 62A-D that matched the query. Web pages 62A and 62C-D have at least one dependency, while web page 62B does not. As such, web pages 62A and 62C-D all have the illustrative icons shown in FIG. 2 corresponding to dependencies that are required for the associated web page. To render search results as shown using server side technology as described above, the following events occurred. First, the web pages 62A-D shown in search results 60 were previously examined for dependencies and indexed by indexing system 34. When the search query was received, it was processed by search engine 31. After web pages 62A-D were identified by search engine, the index created by indexing system 34 was accessed and the corresponding dependencies were identified. Thereafter, client 14 was analyzed or queried via client analysis system 36 to determine if such dependencies existed thereon. Once this was determined, graphics attachment system 38 attached the appropriate graphical dependency indicators (e.g. icons 52A and 54B) to the search results 60, which were then rendered on client 14.

As can be seen from search results 60 of FIG. 3, web pages 62A and 62C-D have dependencies. Icon 52A displayed adjacent to web pages 62A and 62D indicates that client 14 has the necessary plugin. Conversely, icon 54B adjacent web pages 62C-D indicates that client 14 lacks the necessary software application. As mentioned above (and as will be further illustrated below), graphical dependency indicators (e.g., icons 52A-B and 54A-B) can be automatically displayed for user 16 such as in FIG. 3, or they could be displayed upon manual prompting by user. In the case of the latter, web browser 39 could include a mechanism such as an additional icon in its tool bar. Upon selection of the icon in the tool bar by user 16, the graphical dependency indicators can be displayed (e.g., as shown in FIG. 3). This functionality could be incorporated as part of browser 39, or it could be incorporated as part of client dependency system 40 (e.g., within graphics display system 46).

For the dependencies that client 14 lacks, the present invention can provide a mechanism for providing/obtaining the same. In one embodiment, the graphical dependency indicators displayed to user 16 could contain live hyperlinks (as shown for icons 52B and 54B) to one or more appropriate web pages/sites where any missing dependencies could be obtained. For example, upon selecting icon 54B in search results 60, user 16 could access a web page/site for a vendor of the missing software application. In another embodiment, the hyperlinks could be to a central web page/site where any type of dependency could be obtained. Moreover, it should be understood that as indicated above, the graphical dependency indicators displayed to user with a web page or search results could indicate a level in which the dependency would be required. For example, icons 52A-B and 54A-B could be displayed with a number or value that indicates a level of the corresponding website in which the dependency would be needed.

Referring back to FIG. 1, a description of the present invention using client side technology will be explained. To this extent, client 14 is shown including client browser 39 and dependency system 40. Although shown as separate systems, client dependency system 40 could be included within web browser 39 as a plugin or the like. In any event, as depicted, client dependency system 40 includes dependency analysis system 42, internal analysis system 44, graphics display system 46 and resource system 48. In this example, assume that user 16 requested a particular web page via browser 39 (e.g., as opposed to submitting a search query). The request will be received by search engine 31, which would obtain and return the requested web page to client 14. Upon receipt, dependency analysis system 42 would analyze the web page to identify any dependencies therefore. This analysis typically occurs at load time, prior to the display/rendering of the web page. If a set of dependencies are identified, internal analysis system 44 will analyze client 14 to determine if the set of dependencies exists thereon. Based on this analysis, graphical display system 46 could display graphical dependency indicators (e.g., automatically or upon manual prompting by user 16) to indicate the set of dependencies and whether those dependencies exist on client 14. For any dependencies that do not exist on client 14, resource system 48 can provide a link(s) to one or more web page/site where any missing dependencies can be obtained.

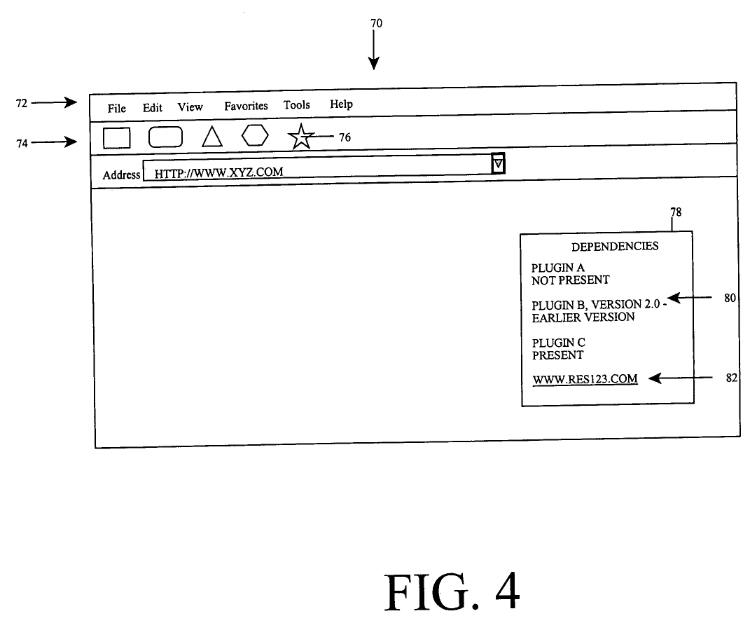

Referring now to FIG. 4, these concepts will be described in greater detail. Specifically, FIG. 4 depicts an illustrative web page 70 “XYZ.COM” as requested by user 16. As known, web page 70 is typically displayed within web browser 39. As such, web page 70 can be displayed with various tool bars 72 and 74. Shown in toolbar 74 is a set of illustrative icons. Icon 76 is provided to demonstrate one example of a mechanism that can be provided for user 16 to manually view dependencies for web page 70. Specifically, as mentioned above, when a web page is displayed for user 16 under the present invention, graphical dependency indicators can be automatically displayed, or they can be displayed upon some manual action of user 16.

FIG. 4 demonstrates the latter. Specifically, tool bar 70 is provided with icon 76, which upon selection by user 16 can cause a pop-up window 78 or the like to be provided. Pop-up window 78 can indicate any dependencies 80 for the web page 70, as well as whether client 14 includes the same. As shown, web page 70 has three dependencies 80, namely, plugins “A-C.” As further shown, only plugin “C” is present and up to date on client 14. That is, plugin “A” is not present at all, while an earlier version of plugin “B” exists on client 14. It should be understood that pop-up window 78 includes graphical dependency indicators in the form of plain text as opposed to the icons of FIG. 2. This is done for illustrative purposes only, and to demonstrate that plain text can be used as a graphical dependency indicator. Thus, it should be understood that icons such as those shown in FIG. 2 could have been used in FIG. 4 in place of or in addition to the plain text. In any event, pop-up window also include one or more links link 82 to another web page/site where missing dependencies can be obtained by user 16. Just as described above, the link can be to a vendor of one or more of the dependencies or to a central location where any needed dependencies can be obtained.

It should be understood that if user 16 had submitted a search query instead of requesting a particular web page, dependency analysis system 42 would analyze the search results and identify any dependencies therefore. This could involve individually analyzing each web page identified in the search results as described above when a single web page is requested. Regardless, the present invention will still function to identify dependencies, determine whether such dependencies exist on the client, and graphically indicate the same.

It should be understood that in addition to dependencies and their availability on client 14, other information could be displayed for user 16, such as that listed below.

(a) web page richness gauge for a search engine result set. Evaluate and visually indicate a web page or web site's level of richness, e.g., display aggregate score based on number and size of images and plugin-dependent elements are incorporated.

(b) browser level/vendor/setting dependencies. Evaluate and visually indicate whether the page markup utilizes features not implemented by the client's current browser version or vendor.

(c) operating system level/vendor/setting dependencies. Evaluate and visually indicate any operating system dependencies. Certain rich HTML features only work on Windows systems.

(d) accessibility indication. Evaluate and visually indicate level of accessibility. This might be very useful for filtering out non-accessible web site.

(e) sound requirements. Evaluate and visually indicate whether page makes use of sound files that would require certain hardware, namely a sound card and speakers.

(f) latency-to-view. Evaluate calculated approximate time needed to gather and install all necessary dependencies. User 16 might decide based on this value whether or not to choose another entry in a search result set. This allows user 16 to make a decision about which web site to actually visit, given the availability of multiple web sites meeting search criteria. For example if user 16 sees that he/she needs QuickTime and Adobe Acrobat to visit Site A, he/she may be more inclined to visit the text-only version of the Site A or even to visit another web site for which he/she already has all the necessary dependencies to view the page.

Referring back to FIG. 1, it should be appreciated that the present invention can be implemented using a combination of client side and server side technology. For example, as mentioned above, client analysis system 36 on server 12 can simply query client 14 for dependencies. In such a case, the actual analysis of client 14 would be performed by internal analysis system 44.

It should be appreciated that the present invention could be offered as a business method on a subscription or fee basis. For example, server 12 and/or client 14 of FIG. 1 could be created, supported, maintained and/or deployed by a service provider that offers the functions described herein for customers. That is, a service provider could offer to identify web page dependencies for web users or clients.

It should also be understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

We claim:

1. A method for identifying web page dependencies, comprising:
identifying a set of dependencies corresponding to a web page prior to rendering the web page;
determining whether a client from which the web page was requested has the set of dependencies; and
graphically indicating the set of dependencies on the client and whether the client has the set of dependencies.

2. The method of claim 1, wherein the identifying step comprises indexing the set of dependencies on a server prior to receiving a request for the web page from the client.

3. The method of claim 1, wherein the identifying step comprises analyzing the web page on the client at load time to identify the set of dependencies.

4. The method of claim 1, wherein the determining step comprises analyzing the client to determine whether the client has the dependencies.

5. The method of claim 1, further comprising receiving a request for the web page from the client, prior to the determining step.

6. The method of claim 1, wherein the set of dependencies comprise components necessary for proper loading or execution of the web page on the client.

7. The method of claim 1, wherein the graphically indicating step comprises displaying icons on the client that correspond to set of dependencies, wherein the icons are displayed in a first manner if the set of dependencies exist on the client and in a second manner if the set of dependencies do not exist on the client.

8. The method of claim 7, further comprising providing a mechanism for displaying the icons.

9. The method of claim 1, further comprising providing a mechanism for obtaining any of the set of dependencies that do not exist on the client.

10. The method of claim 9, wherein the mechanism comprises a link to another web page from which any of the set of dependencies can be obtained.

11. A system for identifying web page dependencies, comprising:
a system for identifying a set of dependencies corresponding to a web page prior to rendering the web page;
a system for determining whether a client from which the web page was requested has the set of dependencies; and
a system for graphically indicating the set of dependencies on the client, and whether the client has the set of dependencies.

12. The system of claim 11, wherein the system for identifying comprises an indexing system that indexes the set of dependencies on a server prior to receiving a request for the web page from the client.

13. The system of claim 11, wherein the system for identifying comprises a dependency analysis system for analyzing the web page on the client at load time to identify the set of dependencies.

14. The system of claim 11, wherein the system for determining comprises a client analysis system for analyzing the client from a server to determine whether the client has the set of dependencies.

15. The system of claim 11, wherein the system for determining comprises an internal analysis system loaded on the client for determining whether the client has the set of dependencies.

16. The system of claim 11, wherein the system for graphically indicating displays icons on the client that correspond to set of dependencies, wherein the icons are displayed in a first manner if the set of dependencies exist on the client and in a second manner if the set of dependencies do not exist on the client.

17. The system of claim 16, wherein the client comprises a system for providing a mechanism for displaying the icons.

18. The system of claim 11, wherein the set of dependencies comprise components necessary for proper loading or execution of the web page on the client.

19. The system of claim 11, wherein the client comprises a resource system for providing a mechanism for obtaining any of the set of dependencies that do not exist on the client.

20. The system of claim 19, wherein the mechanism comprises a link to another web page from which any of the dependencies can be obtained.

21. A program product stored on a recordable medium for identifying web page dependencies, which when executed, comprises:
program code for identifying a set of dependencies corresponding to a web page prior to rendering the web page;
program code for determining whether a client from which the web page was requested has the set of dependencies; and
program code for graphically indicating the set of dependencies on the client, and whether the client has the set of dependencies.

22. The program product of claim 21, wherein the program code for identifying comprises program code that indexes the set of dependencies on a server prior to receiving a request for the web page from the client.

23. The program product of claim 21, wherein the program code for identifying comprises program code for analyzing the web page on the client at load time to identify the set of dependencies.

24. The program product of claim 21, wherein the program code for determining comprises program code for analyzing the client from a server to determine whether the client has the set of dependencies.

25. The program product of claim 21, wherein the program code for determining comprises program code loaded on the client for determining whether the client has the set of dependencies.

26. The program product of claim 21, wherein the program code for graphically indicating displays icons on the client that correspond to set of dependencies, wherein the icons are displayed in a first manner if the set of dependencies exist on the client and in a second manner if the set of dependencies do not exist on the client.

27. The program product of claim 26, wherein the client comprises program code for providing a mechanism for displaying the icons.

28. The program product of claim 21, wherein the set of dependencies comprise components necessary for proper loading or execution of the web page on the client.

29. The program product of claim 21, wherein the client comprises program code for providing a mechanism for obtaining any of the set of dependencies that do not exist on the client.

30. The program product of claim 29, wherein the mechanism comprises a link to another web page from which any of the set of dependencies can be obtained.

31. A method for deploying an application for identifying web page dependencies, comprising:
providing a computer infrastructure being operable to:
identify a set of dependencies corresponding to a web page prior to rendering the web page;
determine whether a client from which the web page was requested has the set of dependencies; and
graphically indicate the set of dependencies on the client, and whether the client has the set of dependencies.

32. Computer software embodied in a propagated signal for identifying web page dependencies, the computer software comprising instructions to cause a computer system to perform the following functions:
identify a set of dependencies corresponding to a web page prior to rendering the web page;
determine whether a client from which the web page was requested has the set of dependencies; and
graphically indicate the set of dependencies on the client, and whether the client has the set of dependencies.
